(19) United States
(12) Patent Application Publication
(10) Pub. No.: US 2025/0276578 A1
(43) Pub. Date: Sep. 4, 2025

(54) DISPLAY DEVICE AND OPTICAL MEMBER

(71) Applicant: Panasonic Automotive Systems Co., Ltd., Kanagawa (JP)

(72) Inventor: Takahiro SHUGYO, Kanagawa Ken (JP)

(73) Assignee: Panasonic Automotive Systems Co., Ltd., Kanagawa (JP)

(21) Appl. No.: 19/054,269

(22) Filed: Feb. 14, 2025

(30) Foreign Application Priority Data
Feb. 29, 2024 (JP) 2024-030626

(51) Int. Cl. B60K 35/22; B60R 1/08

(52) U.S. Cl. CPC B60K 35/22; B60R 1/08; B60K 2360/23; B60K 2360/48; B60K 2360/779

(57) ABSTRACT

A display device includes a display panel, a transmission reflection member, a sensor, and an optical member. The transmission reflection member is provided in front of the display panel. The sensor detects an amount of light corresponding to incident light incident onto the transmission reflection member. The optical member is provided near the transmission reflection member. The optical member includes reflective surfaces continuing to each other. The optical member receives light and reflects the light by the reflective surfaces. The optical member guides the reflected light to the sensor. The reflective surfaces constitute a polygonal surface bulging out toward an opposite side of an incident side with respect to a virtual plane defined by outer contours of the reflective surfaces.

### CROSS-REFERENCE TO RELATED APPLICATIONS

This application is based upon and claims the benefit of priority from Japanese Patent Application No. 2024-030626, filed on Feb. 29, 2024, the entire contents of which are incorporated herein by reference.

### FIELD

The present disclosure relates generally to a display device and an optical member.

### BACKGROUND

A display device that includes a display panel, a transmission reflection member provided in front of the display panel, and a sensor has been known. In such a display device, an amount of light corresponding to incident light incident onto the transmission reflection member is detected by the sensor in an operation mode in which the display panel is turned off (see, for example, Patent Literature: JP 2017-183758 A).

For the above-described display device, it is desirable that the amount of light corresponding to the incident light on the transmission reflection member be appropriately detected by the sensor.

### SUMMARY

A display device according to one aspect of the present disclosure includes a display panel, a transmission reflection member, a sensor, and an optical member. The transmission reflection member is provided in front of the display panel. The sensor is configured to detect an amount of light corresponding to incident light incident onto the transmission reflection member. The optical member is provided near the transmission reflection member. The optical member includes reflective surfaces continuing to each other. The optical member is configured to receive light, reflect the light by the reflective surfaces, and guide the reflected light to the sensor. The reflective surfaces constitute a polygonal surface bulging out toward an opposite side of an incident side with respect to a virtual plane defined by outer contours of the reflective surfaces.

### BRIEF DESCRIPTION OF THE DRAWINGS

FIG. 1 is a diagram schematically illustrating a vehicle on which a display system including a display device according to an embodiment is installed;

FIG. 2 is a perspective view illustrating an external configuration of the display device according to the embodiment;

FIG. 3 is a front view illustrating the external configuration of the display device according to the embodiment;

FIG. 4 is a cross-sectional view illustrating a configuration of the display device according to the embodiment;

FIG. 5 is a perspective view illustrating a configuration of an optical member in the embodiment;

FIG. 6 is a vertical cross-sectional view illustrating the configuration of the optical member in the embodiment;

FIG. 7 is a cross-sectional view in a planar direction, illustrating the configuration of the optical member in the embodiment;

FIG. 8 is a perspective view illustrating an operation of the optical member in the embodiment;

FIG. 9 is a diagram illustrating vertical angle dependency of sensor sensitivity in the embodiment;

FIG. 10 is a perspective view illustrating the operation of the optical member in the embodiment;

FIG. 11 is a diagram illustrating horizontal angle dependency of sensor sensitivity in the embodiment;

FIG. 12 is a perspective view illustrating a configuration of an optical member in a modification of the embodiment;

FIG. 13 is a vertical cross-sectional view illustrating the configuration of the optical member in the modification of the embodiment; and

FIG. 14 is a cross-sectional view in a planar direction, illustrating the configuration of the optical member in the modification of the embodiment.

### DETAILED DESCRIPTION

Hereinafter, an embodiment of a display device according to the present disclosure will be described with reference to the drawings.

### Embodiment

While a display device according to an embodiment includes a display panel, a transmission reflection member provided in front of the display panel, and a sensor, and detects an amount of light corresponding to incident light incident onto the transmission reflection member by the sensor, contrivance for appropriately detecting the amount of light by the sensor has been conducted.

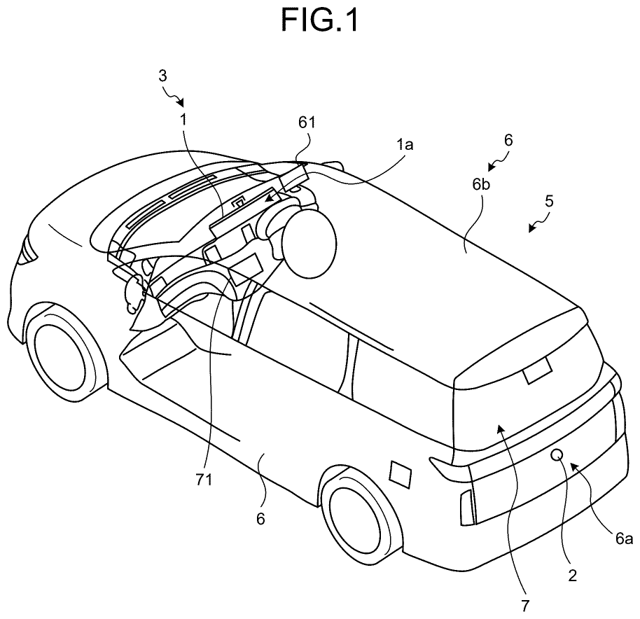

A display system 3 including a display device 1 according to the embodiment can be installed in a vehicle 5, as illustrated in FIG. 1. In one example, the display device 1 is an electronic mirror, and the display system 3 is an electronic mirror system.

FIG. 1 is a diagram illustrating the vehicle 5 on which the display system 3 is installed. The display system 3 includes the display device 1 and an imaging device 2.

The imaging device 2 is an in-vehicle camera installed in the vehicle 5, and is installed outside or inside a vehicle body 6. The imaging device 2 may be installed at an end part on the rear side of the vehicle body 6 to image the rear, may be installed at an end part near the door of the vehicle body 6 to image the side, or may be installed at an end part on the front side of the vehicle body 6 to image the front.

The display device 1 is provided in a vehicle compartment 7. The display device 1 is, for example, an electronic mirror. The display device 1 has a front surface 1a and can display an image acquired by the imaging device 2 on the front surface 1a. The display device 1 is configured to be switchable between a display mode and a mirror mode. The display mode is a mode in which a display panel in the display device 1 displays an image captured by the imaging device 2 and thereby the display device 1 functions as a display. The mirror mode is a mode in which the display panel in the display device 1 is turned off and thereby the display device 1 functions as a mirror.

In a case where the display device 1 is an electronic mirror used for rear visual recognition, the display device 1 may be installed in the form of a rearview mirror. In this case, the front surface 1a may face the vehicle compartment 7, and the shape of the front surface 1a may be the shape of the mirror surface of the rearview mirror. In a case where the display device 1 is an electronic mirror for side visual recognition, the display device 1 may be installed in the form of a door mirror (for example, a door mirror 61). In this case, the front surface 1a may face the rear of the vehicle body 6, and the shape of the front surface 1a may be the shape of the mirror surface of the door mirror. In a case where the display device 1 is an electronic mirror for front visual recognition, the display device 1 may be installed in the form of a vehicle-installed display device (for example, a display device 71). In this case, and the front surface 1a may face the vehicle compartment 7, and the shape of the front surface 1a may be the shape of a display panel of the vehicle-installed display device (71).

In the example illustrated in FIG. 1, the imaging device 2 is installed at a rear end part 6a of the vehicle body 6, and the display device 1 is applied to an electronic mirror system for rear visual recognition. The electronic mirror system for rear visual recognition is also called an electronic rearview mirror. The imaging device 2 acquires an image behind the vehicle body. The display device 1 can display an image of the rear side of the vehicle body, in which the image is captured by the imaging device 2.

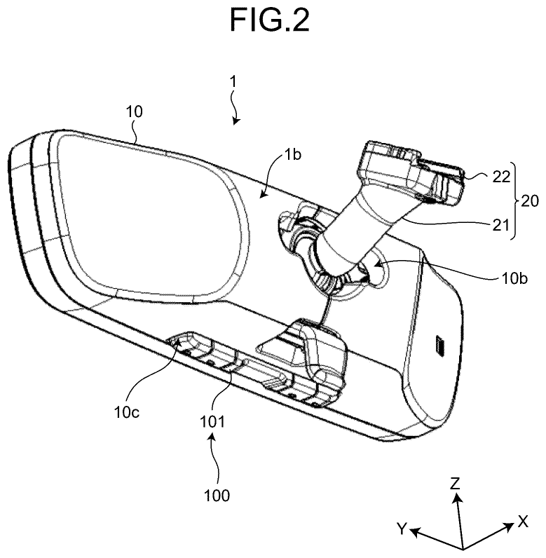

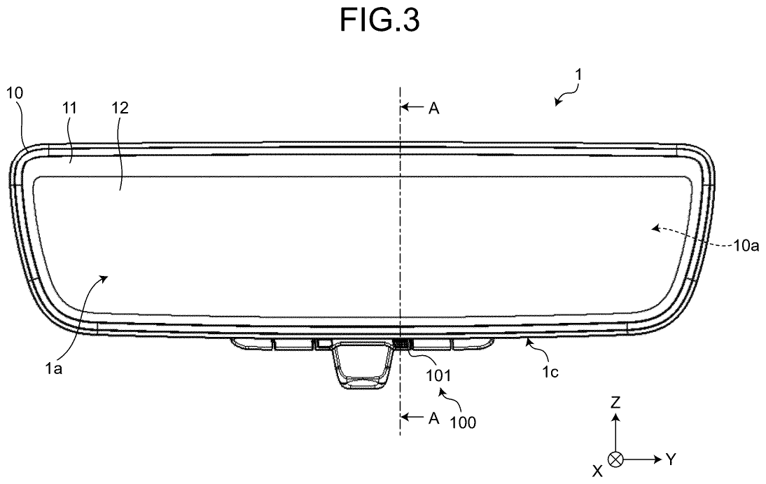

When the display device 1 is an electronic mirror for rear visual recognition, the display device 1 can be configured as illustrated in FIGS. 2 and 3. FIG. 2 is a perspective view illustrating an external configuration of the display device 1. FIG. 3 is a front view illustrating an external configuration of the display device 1.

The display device 1 may have a back surface 1b on the opposite side of the front surface 1a, and may be fixed to the vehicle body of the vehicle 5 via a fixing member 20 on the back surface 1b side. The display device 1 includes a housing 10, a transmission reflection member 11, a display panel 12, and an optical member 100.

The housing 10 has a substantially rectangular parallelepiped appearance shape. Hereinafter, a direction perpendicular to the front surface 1a of the display device 1 is referred to as the X direction, a longitudinal direction of the housing 10 is referred to as the Y direction, and a direction perpendicular to the X direction and the Y direction is referred to as the Z direction. The housing 10 has an opening 10a on the −X side, an opening 10b on the +X side, and an opening 10c on the −Z side.

One end of an arm 21 in the fixing member 20 is rotatably inserted into the opening 10b. The other end of the arm 21 is connected to an installation member 22 in the fixing member 20. The installation member 22 may be attached inside the vehicle body 6. Accordingly, the housing 10 can be fixed to the vehicle body 6.

The transmission reflection member 11 is provided on the −X side of the display panel 12 and is fixed to the housing 10 from the −X side. The transmission reflection member 11 extends in a plate shape in the YZ direction and has a substantially rectangular shape or a substantially inverted isosceles trapezoidal shape in YZ plane view. In the transmission reflection member 11, corners of a substantially rectangular shape or a substantially inverted isosceles trapezoidal shape may be rounded. The transmission reflection member 11 has a YZ dimension corresponding to the opening 10a. The Y width of the transmission reflection member 11 is slightly larger than the Y width of the opening 10a. The Z width of the transmission reflection member 11 is slightly larger than the Z width of the opening 10a. Thus, the transmission reflection member 11 can close the opening 10a from the −X side.

The display panel 12 is provided on the +X side of the transmission reflection member 11 and is housed in the housing 10. The display panel 12 extends in a plate shape in the YZ direction and has a substantially rectangular shape in YZ plane view. The display panel 12 has a YZ dimension corresponding to the opening 10a. The Y width of the display panel 12 is slightly larger than the Y width of the opening 10a. The Z width of the display panel 12 is slightly larger than the Z width of the opening 10a. Consequently, the display panel 12 can close the opening 10a from the +X side.

The optical member 100 is provided near the transmission reflection member 11. The optical member 100 can be provided on the −Z side of the transmission reflection member 11. In the optical member 100, an incident surface 101 protrudes from the opening 10c to the −Z side. The incident surface 101 faces the −X side and receives light incident from the −X side. Light from a headlight of another vehicle, which is present behind the vehicle 5, can be incident onto an incident surface 101a. The optical member 100 may be made of material with translucency. The optical member 100 may be made of glass, quartz, transparent plastic, or the like.

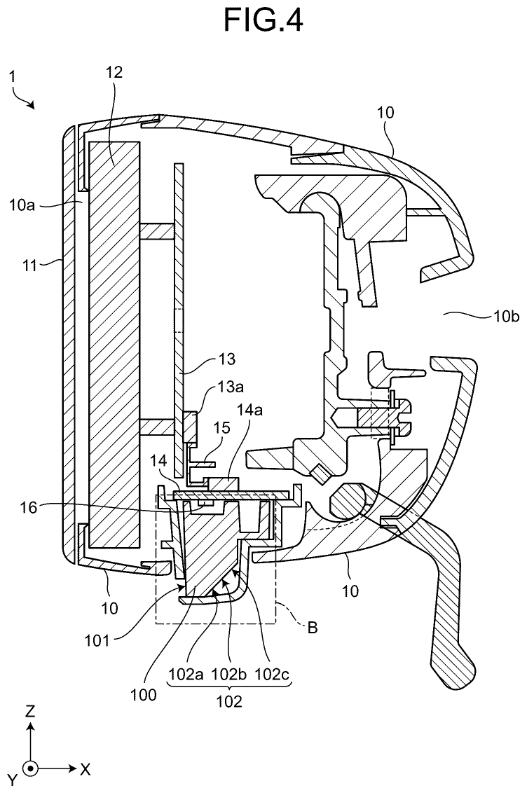

FIG. 4 is a cross-sectional view illustrating a configuration of the display device. FIG. 4 illustrates a cross section of FIG. 3 taken along line A-A. As illustrated in FIG. 4, the display device 1 further includes a substrate 13, a substrate 14, a flexible flat cable (FFC) 15, and a sensor 16.

The substrate 13 is provided on the +X side of the display panel 12 and is housed in the housing 10. The substrate 13 extends in a plate shape in the YZ direction and has a substantially rectangular shape in YZ plane view. The substrate 13 may have a smaller dimension than that of the display panel 12 in YZ plane view. The −Z side end part of the substrate 13 may be located closer to the +Z side than the −Z side end part of the display panel 12. A control circuit element 13a may be installed in the +X side surface of the substrate 13. The control circuit element 13a may include a circuit for controlling the reflectance of the transmission reflection member 11.

The substrate 14 is provided between the substrate 13 and the optical member 100. The substrate 14 is provided on the −Z side of the substrate 13, is provided on the +Z side of the optical member 100, and is housed in the housing 10. The substrate 13 extends in the plate shape in the XY direction and has a substantially rectangular shape in XY plan view. The substrate 14 may be larger in size than the optical member 100 in XY plane view. A control circuit element 14a may be installed in the +Z side surface of the substrate 14. The control circuit element 14a may include a circuit for controlling the reflectance of the transmission reflection member 11.

The FFC 15 may be a bendable film-shaped cable. The FFC 15 is provided between the control circuit element 13a and the control circuit element 14a. One end of the FFC 15 is electrically connected to the control circuit element 13a, and the other end thereof is electrically connected to the control circuit element 14a.

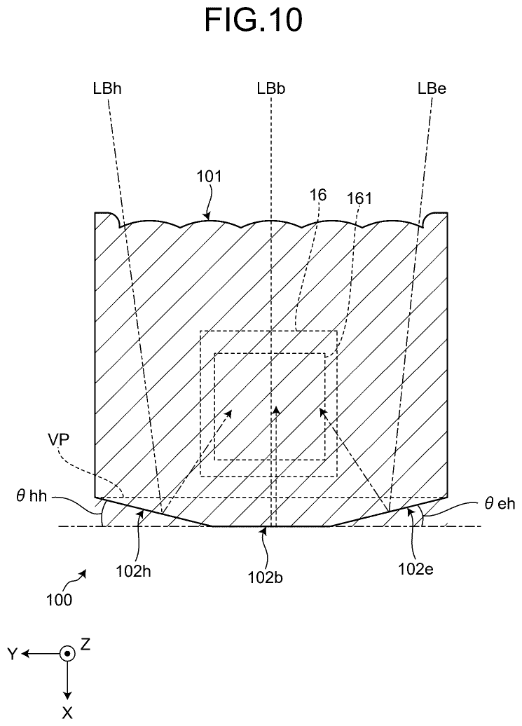

The sensor 16 is installed in the −Z side surface of the substrate 14 and is housed in the housing 10. The sensor 16 can detect the amount of light. The sensor 16 is an illuminance sensor, and may be, for example, a silicon photosensor. In the sensor 16, a light reception region 161 (refer to FIG. 10) has an area of A1. The sensor 16 can accumulate a charge corresponding to light received on the light reception surface and output a signal corresponding to the accumulated charge as a detection result. The sensor 16 may be electrically connected to the control circuit element 14a via wiring in the substrate 14. With this configuration, the sensor 16 can transmit the detection result to the control circuit element 13a via the wiring in the substrate 14, the control circuit element 14a, and the FFC 15. With this configuration, the control circuit element 13a can adjust the reflectance of the transmission reflection member 11 to reflectance corresponding to the amount of light detected by the sensor 16.

In one example, the control circuit element 13a controls, in a normal state, the reflectance of the transmission reflection member 11 to be RR1 in a state where the display device 1 operates in the mirror mode, and then controls the reflectance of the transmission reflection member 11 to be RR2 (<RR1) when the amount of light detected by the sensor 16 exceeds a threshold amount of light. With this processing, if the front surface 1a receives light from a headlight of another vehicle behind the vehicle 5, the intensity of the light that has been reflected by the front surface 1a and visually recognized by a passenger of the vehicle 5 can be suppressed. Therefore, the convenience for the passenger of the vehicle 5 can be improved.

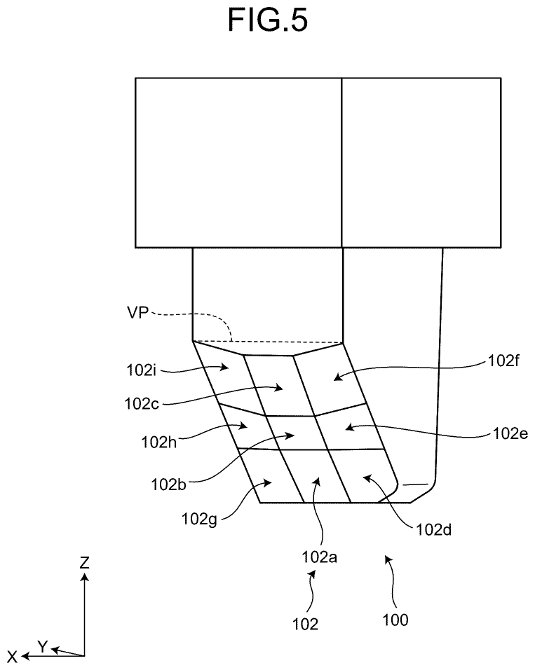

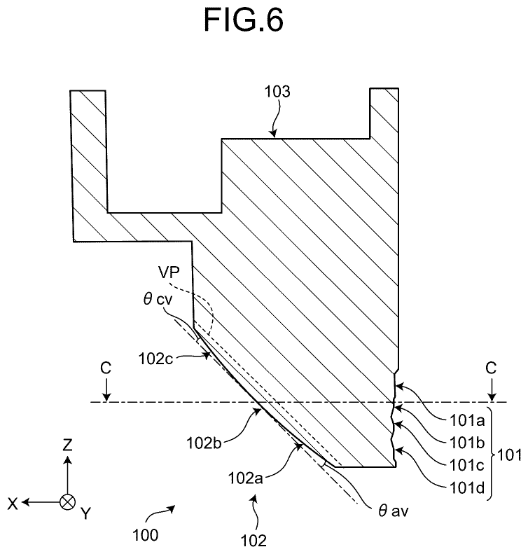

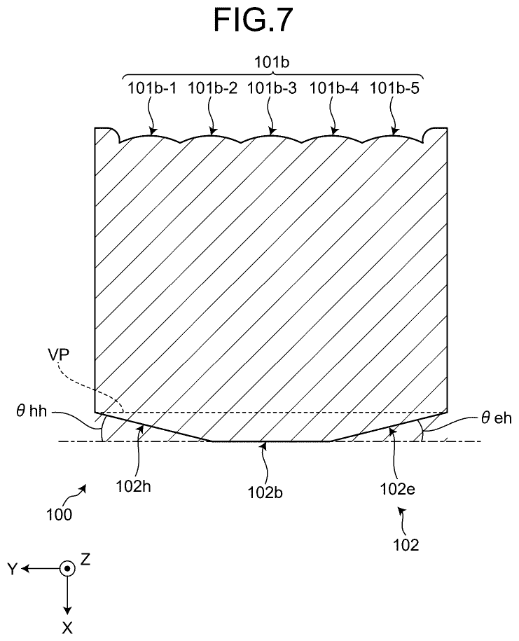

The optical member 100 is provided on the −Z side of the sensor 16. As illustrated in FIGS. 5 to 7, the optical member 100 has plural reflective surfaces 102a to 102i continuing to each other. FIG. 5 is a perspective view illustrating a configuration of the optical member 100. FIG. 6 is an XZ cross-sectional view illustrating the configuration of the optical member 100, and is an XZ enlarged cross-sectional view of a section B in FIG. 4 as viewed from the −Y direction. FIG. 7 is an XY cross-sectional view illustrating the configuration of the optical member 100, and illustrates a cross section of FIG. 6 taken along line C-C.

The optical member 100 includes a reflective surface group 102 and an emitting surface 103 in addition to the incident surface 101. The incident surface 101 is provided at positions on the −X side and the −Z side of the optical member 100, is exposed as an outer surface of the optical member 100, and faces the −X side. The reflective surface group 102 is provided on the +X side of the incident surface 101. The reflective surface group 102 is provided at positions on the +X side and the −Z side in the optical member 100 and faces a direction inclining to the −X side and the +Z side in the optical member 100. The emitting surface 103 is provided on the +Z side of the reflective surface group 102. The emitting surface 103 is provided at a position on the +Z side in the optical member 100, is exposed as an outer surface of the optical member 100, and faces the +Z side.

The optical member 100 receives light incident from the −X side by the incident surface 101 and reflects the received light by the reflective surface group 102. The optical member 100 then emits the reflected light from the emitting surface 103 and guides the reflected light to the sensor 16. The reflective surface group 102 is provided between the incident surface 101 and the emitting surface 103 in the optical path.

The reflective surface group 102 includes the reflective surfaces 102a to 102i continuing to each other. The reflective surfaces 102a to 102i constitute a polygonal surface bulging out toward the opposite side of the incident side with respect to a virtual plane VP. The virtual plane VP is defined by the outer contours of the reflective surfaces 102a to 102i (refer to FIG. 5). With this configuration, the optical member 100 can guide the incident light from the −X side to the sensor 16 in a wide angle range, and can expand the angle range in which the sensor 16 can detect the amount of light.

The incident surface 101 includes convex surfaces 101a_1 to 101a_5, 101b_1 to 101b_5, 101c_1 to 101c_5, and 101d_1 to 104d_5. Each of the convex surfaces 101a_1 to 104d_5 includes a curved surface that is convex to the −X side. With this structure, the optical member 100 can receive light in a wide angle range on the incident surface 101.

In the present specification, regarding an incident angle of light onto the incident surface 101, an incident angle in the vertical direction and an incident angle in the horizontal direction are each considered. It is assumed that the incident surface 101 is a surface extending substantially in the YZ direction, and the −X direction is a normal direction of the incident surface 101. The incident angle in the vertical direction with respect to the incident surface 101 is defined such that an angle formed clockwise in the −X direction is defined as a positive angle and an angle formed counterclockwise is defined as a negative angle when viewed from the −Y direction. The incident angle in the horizontal direction with respect to the incident surface 101 is defined such that an angle formed clockwise in the −X direction is defined as a positive angle and an angle formed counterclockwise is defined as a negative angle when viewed from the +Z direction.

The reflective surfaces 102a to 102i included in the reflective surface group 102 incline and continue to each other, thereby constituting a polygonal surface.

In the present specification, the inclination angle in the vertical direction and the inclination angle in the horizontal direction are each considered for the inclination angles of the two reflective surfaces. An inclination angle of a first reflective surface in the vertical direction with respect to a second reflective surface is defined such that an angle formed clockwise with respect to the second reflective surface is defined as a positive angle and an angle formed counterclockwise with respect to the second reflective surface is defined as a negative angle when viewed from the −Y direction. An inclination angle of the first reflective surface in the horizontal direction with respect to the second reflective surface is defined such that an angle formed clockwise with respect to the second reflective surface is defined as a positive angle and an angle formed counterclockwise with respect to the second reflective surface is defined as a negative angle when viewed from the +Z direction.

The reflective surfaces 102a to 102i are obtained by dividing the virtual plane VP by 3×3 and deforming the virtual plane VP so as to bulge out toward the opposite side of the incident side while keeping a state where 3×3 reflective surfaces are connected to each other. The reflective surfaces 102a to 102i are connected to each other via straight sides.

The reflective surfaces 102a to 102i incline at an angle to each other. Among the reflective surfaces 102a to 102i, the reflective surface 102b extends along the virtual plane VP, and the reflective surfaces 102a and 102c to 102i extend obliquely to the virtual plane VP.

The reflective surfaces 102a to 102i may have different incident angles of incident light to be respectively reflected. The reflective surface 102b is allotted incident light having a relatively small incident angle. The reflective surfaces 102a and 102c are allotted incident light having a relatively large incident angle in the vertical direction on the positive side and the negative side, respectively. The reflective surfaces 102e and 102h are allotted incident light having a relatively large incident angle in the horizontal direction on the positive side and the negative side, respectively. The reflective surfaces 102d and 102g are allotted incident light having a relatively large incident angle in the vertical direction on the positive side and a relatively large incident angle in the horizontal direction on the positive side and the negative side, respectively. The reflective surfaces 102i and 102f are allotted incident light having a relatively large incident angle in the vertical direction on the negative side and a relatively large incident angle in the horizontal direction on the positive side and the negative side, respectively.

Each of the reflective surfaces 102a to 102i has a substantially rectangular shape in plan view. The areas of the respective reflective surfaces 102a to 102i may be equal to each other. The areas of the respective reflective surfaces 102a to 102i may be equal to or larger than the area A1 of the light reception region 161 of the sensor 16. The area of each of the reflective surfaces 102a to 102i is preferably 1.5 mm×1.5 mm=2.25 mm² or more. The area of each of the reflective surfaces 102a to 102i is more preferably 3 mm×3 mm=9 mm² or more.

The reflective surface 102b is provided at the center of the reflective surfaces 102a to 102i. The reflective surface 102b is connected to the reflective surface 102a at the side on the −Z side, connected to the reflective surface 102c at the side on the +Z side, connected to the reflective surface 102e at the side on the −Y side, and connected to the reflective surface 102h at the side on the +Y side. The corner of the reflective surface 102b on the −Y side and the −Z side is in contact with the corner of the reflective surface 102d, the corner of the reflective surface 102b on the −Y side and the +Z side is in contact with the corner of the reflective surface 102f, the corner of the reflective surface 102b on the +Y side and the −Z side is in contact with the corner of the reflective surface 102g, and the corner of the reflective surface 102b on the +Y side and the +Z side is in contact with the corner of the reflective surface 102i. The reflective surface 102b may be substantially parallel to the virtual plane VP (refer to FIGS. 6 and 7). The area of the reflective surface 102b may be smaller than the area of each of the other reflective surfaces 102a and 102c to 102i.

The reflective surface 102a is provided on the −Z side of the reflective surface 102b and is connected to the reflective surface 102b at the side on the +Z side. The reflective surface 102a inclines with respect to the reflective surface 102b such that the −Z side is closer to the virtual plane VP than the +Z side. An angle between the reflective surface 102a and the virtual plane VP corresponds to the incident angle of light to the incident surface 101. An angle between the reflective surface 102a and the reflective surface 102b corresponds to the incident angle of light to the incident surface 101. An inclination angle θah of the reflective surface 102a in the horizontal direction with respect to the reflective surface 102b corresponds to an incident angle of light in the horizontal direction to be covered by the reflective surface 102a. An inclination angle θav of the reflective surface 102a in the vertical direction with respect to the reflective surface 102b corresponds to an incident angle of light in the vertical direction to be covered by the reflective surface 102a.

The reflective surface 102a is allotted incident light having a relatively large incident angle in the vertical direction on the positive side. The angle between the reflective surface 102a and the reflective surface 102b may be about ¼ of the incident angle of the incident light to be covered by the reflective surface 102a. If the optical member 100 is required to cover incident light having an incident angle of −10° or more and +10° or less in the vertical direction, the inclination angle θav of the reflective surface 102a in the vertical direction with respect to the reflective surface 102b may be approximately 2.5°. The inclination angle θah (refer to FIG. 6) of the reflective surface 102a in the horizontal direction with respect to the reflective surface 102b may be substantially 0.

The reflective surface 102c is provided on the +Z side of the reflective surface 102b, and is connected to the reflective surface 102b at the side on the −Z side. The reflective surface 102c inclines with respect to the reflective surface 102b such that the +Z side is closer to the virtual plane VP than the −Z side. An angle between the reflective surface 102c and the virtual plane VP corresponds to the incident angle of light to the incident surface 101. An angle between the reflective surface 102c and the reflective surface 102b corresponds to the incident angle of light to the incident surface 101. An inclination angle θch of the reflective surface 102c in the horizontal direction with respect to the reflective surface 102b corresponds to an incident angle of light in the horizontal direction to be covered by the reflective surface 102c. An inclination angle θcv of the reflective surface 102c in the vertical direction with respect to the reflective surface 102b corresponds to an incident angle of light in the vertical direction to be covered by the reflective surface 102c.

The reflective surface 102c is allotted incident light having a relatively large incident angle in the vertical direction on the positive side. The angle between the reflective surface 102c and the reflective surface 102b may be about ¼ of the incident angle of the incident light to be covered by the reflective surface 102c. If the optical member 100 is required to cover incident light having an incident angle of −10° or more and +10° or less in the vertical direction, the inclination angle θcv (refer to FIG. 6) of the reflective surface 102c in the vertical direction with respect to the reflective surface 102b may be approximately −2.5°. The inclination angle θch of the reflective surface 102c in the horizontal direction with respect to the reflective surface 102b may be substantially 0.

The reflective surface 102d is provided on the −Y side and the −Z side of the reflective surface 102b, and the corner of the reflective surface 102d on the +Y side and the +Z side is in contact with the corner of the reflective surface 102b. The reflective surface 102d inclines with respect to the reflective surface 102b such that the corner of the reflective surface 102d on the −Y side and the −Z side is closer to the virtual plane VP than the corner thereof on the +Y side and the +Z side. An angle between the reflective surface 102d and the virtual plane VP corresponds to the incident angle of light to the incident surface 101. An angle between the reflective surface 102d and the reflective surface 102b corresponds to the incident angle of light to the incident surface 101. An inclination angle θdh of the reflective surface 102d in the horizontal direction with respect to the reflective surface 102b corresponds to an incident angle of light in the horizontal direction to be covered by the reflective surface 102d. An inclination angle θdv of the reflective surface 102d in the vertical direction with respect to the reflective surface 102b corresponds to an incident angle of light in the vertical direction to be covered by the reflective surface 102d. An absolute value of the inclination angle θdv in the vertical direction may be smaller than an absolute value of the inclination angle θdh in the horizontal direction.

The reflective surface 102d is allotted incident light having a relatively large incident angle in the vertical direction on the positive side and a relatively large incident angle in the horizontal direction on the positive side. The angle between the reflective surface 102d and the reflective surface 102b may be about ¼ of the incident angle of the incident light to be covered by the reflective surface 102d. If the optical member 100 is required to cover incident light having an incident angle of −10° or more and +10° or less in the vertical direction and an incident angle of −35° or more and +35° or less in the horizontal direction, the inclination angle θdv of the reflective surface 102d in the vertical direction with respect to the reflective surface 102b may be approximately 2.5°. The inclination angle θdh of the reflective surface 102d in the horizontal direction with respect to the reflective surface 102b may be approximately 10°.

The reflective surface 102e is provided on the −Y side of the reflective surface 102b and is connected to the reflective surface 102b at the side on the +Y side. The reflective surface 102e inclines with respect to the reflective surface 102b such that the side on the −Y side is closer to the virtual plane VP than the side on the +Y side. An angle between the reflective surface 102e and the virtual plane VP corresponds to the incident angle of light to the incident surface 101. An angle between the reflective surface 102e and the reflective surface 102b corresponds to the incident angle of light to the incident surface 101. An inclination angle θeh the reflective surface 102e in the horizontal direction with respect to the reflective surface 102b corresponds to an incident angle of light in the horizontal direction to be covered by the reflective surface 102e. An inclination angle θev of the reflective surface 102e in the vertical direction with respect to the reflective surface 102b corresponds to an incident angle of light in the vertical direction to be covered by the reflective surface 102e. An absolute value of the inclination angle θev in the vertical direction may be smaller than an absolute value of the inclination angle θeh in the horizontal direction.

The reflective surface 102e is allotted incident light having a relatively large incident angle in the horizontal direction on the positive side. The angle between the reflective surface 102e and the reflective surface 102b may be about ¼ of the incident angle of the incident light to be covered by the reflective surface 102e. If the optical member 100 is required to cover incident light having an incident angle of −35° or more and +35° or less in the horizontal direction, the inclination angle θch (refer to FIG. 7) of the reflective surface 102e in the horizontal direction with respect to the reflective surface 102b may be approximately 10°. The inclination angle θev of the reflective surface 102e in the vertical direction with respect to the reflective surface 102b may be substantially 0.

The reflective surface 102f is provided on the −Y side and the +Z side of the reflective surface 102b, and the corner of the reflective surface 102f on the +Y side and the −Z side is in contact with the corner of the reflective surface 102b. The reflective surface 102f inclines with respect to the reflective surface 102b such that the corner of the reflective surface 102f on the −Y side and the +Z side is closer to the virtual plane VP than the corner thereof on the +Y side and the −Z side. An angle between the reflective surface 102f and the virtual plane VP corresponds to the incident angle of light to the incident surface 101. An angle between the reflective surface 102f and the reflective surface 102b corresponds to the incident angle of light to the incident surface 101. An inclination angle θfh of the reflective surface 102f in the horizontal direction with respect to the reflective surface 102b corresponds to an incident angle of light in the horizontal direction to be covered by the reflective surface 102f. An inclination angle θfv of the reflective surface 102f in the vertical direction with respect to the reflective surface 102b corresponds to an incident angle of light in the vertical direction to be covered by the reflective surface 102f. An absolute value of the inclination angle θfv in the vertical direction may be smaller than an absolute value of the inclination angle θfh in the horizontal direction.

The reflective surface 102f is allotted incident light having a relatively large incident angle in the vertical direction on the negative side and a relatively large incident angle in the horizontal direction on the negative side. The angle between the reflective surface 102f and the reflective surface 102b may be about ¼ of the incident angle of the incident light to be covered by the reflective surface 102f. If the optical member 100 is required to cover incident light having an incident angle of −10° or more and +10° or less in the vertical direction and an incident angle of −35° or more and +35° or less in the horizontal direction, the inclination angle θfv of the reflective surface 102f in the vertical direction with respect to the reflective surface 102b may be approximately −2.5°. The inclination angle θfh of the reflective surface 102f in the horizontal direction with respect to the reflective surface 102b may be approximately 10°.

The reflective surface 102g is provided on the +Y side and the −Z side of the reflective surface 102b, and the corner of the reflective surface 102g on the −Y side and the +Z side is in contact with the corner of the reflective surface 102b. The reflective surface 102g inclines with respect to the reflective surface 102b such that the corner of the reflective surface 102g on the +Y side and the −Z side is closer to the virtual plane VP than the corner thereof on the −Y side and the +Z side. An angle between the reflective surface 102g and the virtual plane VP corresponds to the incident angle of light to the incident surface 101. An angle between the reflective surface 102g and the reflective surface 102b corresponds to the incident angle of light to the incident surface 101. An inclination angle θgh of the reflective surface 102g in the horizontal direction with respect to the reflective surface 102b corresponds to the incident angle of light in the horizontal direction to be covered by the reflective surface 102g. An inclination angle θgv of the reflective surface 102g in the vertical direction with respect to the reflective surface 102b corresponds to an incident angle of light in the vertical direction to be covered by the reflective surface 102g. An absolute value of the inclination angle θgv in the vertical direction may be smaller than an absolute value of the inclination angle θgh in the horizontal direction.

Each of the reflective surfaces 102g is allotted incident light having a relatively large incident angle in the vertical direction on the positive side and a relatively large incident angle in the horizontal direction on the negative side. The angle between the reflective surface 102a and the reflective surface 102b may be about ¼ of the incident angle of the incident light to be covered by the reflective surface 102a. If the optical member 100 is required to cover incident light having an incident angle of −10° or more and +10° or less in the vertical direction, the inclination angle θgv of the reflective surface 102g in the vertical direction with respect to the reflective surface 102b may be approximately 2.5°. The inclination angle θgh of the reflective surface 102g in the horizontal direction with respect to the reflective surface 102b may be approximately −10°.

The reflective surface 102h is provided on the +Y side of the reflective surface 102b and is connected to the reflective surface 102b at the side on the −Y side. The reflective surface 102h inclines with respect to the reflective surface 102b such that the side of the reflective surface 102h on the +Y side is closer to the virtual plane VP than the side thereof on the −Y side. An angle between the reflective surface 102h and the virtual plane VP corresponds to the incident angle of light to the incident surface 101. An angle between the reflective surface 102h and the reflective surface 102b corresponds to the incident angle of light to the incident surface 101. An inclination angle θhh of the reflective surface 102h in the horizontal direction with respect to the reflective surface 102b corresponds to an incident angle of light in the horizontal direction to be covered by the reflective surface 102h. An inclination angle θhv of the reflective surface 102h in the vertical direction with respect to the reflective surface 102b corresponds to an incident angle of light in the vertical direction to be covered by the reflective surface 102h. An absolute value of the inclination angle θhv in the vertical direction may be smaller than an absolute value of the inclination angle θhh in the horizontal direction.

The reflective surface 102h is allotted incident light having a relatively large incident angle in the horizontal direction on the negative side. The angle between the reflective surface 102h and the reflective surface 102b may be about ¼ of the incident angle of the incident light to be covered by the reflective surface 102h. If the optical member 100 is required to cover incident light having an incident angle of −35° or more and +35° or less in the horizontal direction, the inclination angle θhh (refer to FIG. 7) of the reflective surface 102h in the horizontal direction with respect to the reflective surface 102b may be approximately −10°. The inclination angle θhv of the reflective surface 102h in the vertical direction with respect to the reflective surface 102b may be substantially 0.

The reflective surface 102i is provided on the +Y side and the +Z side of the reflective surface 102b, and the corner of the reflective surface 102i on the −Y side and the −Z side is in contact with the corner of the reflective surface 102b. The reflective surface 102i inclines with respect to the reflective surface 102b such that the corner of the reflective surface 102i on the +Y side and the +Z side is closer to the virtual plane VP than the corner thereof on the −Y side and the −Z side. An angle between the reflective surface 102i and the virtual plane VP corresponds to the incident angle of light to the incident surface 101. An angle between the reflective surface 102i and the reflective surface 102b corresponds to the incident angle of light to the incident surface 101. An inclination angle θih of the reflective surface 102i in the horizontal direction with respect to the reflective surface 102b corresponds to an incident angle of light in the horizontal direction to be covered by the reflective surface 102i. An inclination angle θiv of the reflective surface 102i in the vertical direction with respect to the reflective surface 102b corresponds to an incident angle of light in the vertical direction to be covered by the reflective surface 102i. An absolute value of the inclination angle θiv in the vertical direction may be smaller than an absolute value of the inclination angle θih in the horizontal direction.

The reflective surface 102i is allotted incident light having a relatively large incident angle in the vertical direction on the negative side and a relatively large incident angle in the horizontal direction on the positive side. The angle between the reflective surface 102i and the reflective surface 102b may be about ¼ of the incident angle of the incident light to be covered by the reflective surface 102i. If the optical member 100 is required to cover incident light having an incident angle of −10° or more and +10° or less in the vertical direction and an incident angle of −35° or more and +35° or less in the horizontal direction, the inclination angle θiv of the reflective surface 102i in the vertical direction with respect to the reflective surface 102b may be approximately −2.5°. The inclination angle θih of the reflective surface 102i in the horizontal direction with respect to the reflective surface 102b may be approximately −10°.

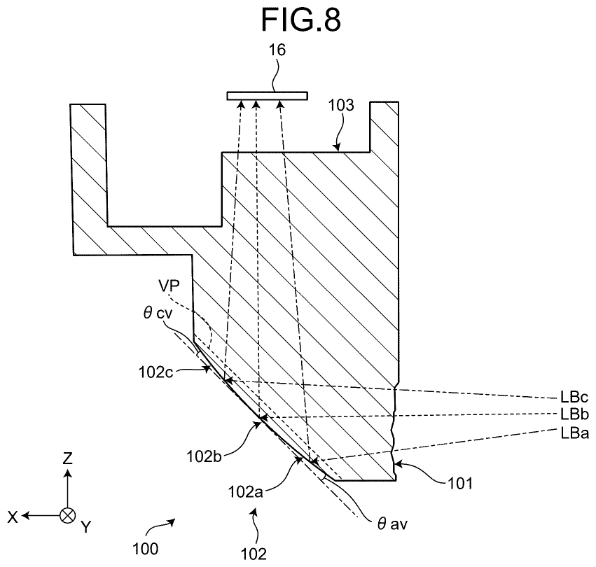

The reflective surface 102b is substantially parallel to the virtual plane VP. Therefore, as indicated by a dotted arrow in FIG. 8, light LBb incident onto the incident surface 101 in the X direction is reflected by the reflective surface 102b and is easily guided to the sensor 16. However, assuming that light LBa incident onto the incident surface 101 from the direction inclining to the −X side and the +Z side with respect to the X direction is reflected by the virtual plane VP, the light LBa may be emitted in a direction deviating from the sensor 16. Assuming that light LBc incident onto the incident surface 101 from the direction inclining to the −X side and the −Z side with respect to the X direction is reflected by the virtual plane VP, the light LBc may be emitted in a direction deviating from the sensor 16.

On the other hand, the reflective surface 102a inclines at the inclination angle θav (>0) in the vertical direction with respect to the virtual plane VP. Therefore, the light LBa incident onto the incident surface 101 from the direction inclining to the −X side and the +Z side in the X direction is reflected by the reflective surface 102a and is easily guided to the sensor 16, as indicated by an arrow of a one-dot chain line in FIG. 8.

The reflective surface 102c inclines at the inclination angle θcv (<0) in the vertical direction with respect to the virtual plane VP. Therefore, the light LBc incident onto the incident surface 101 from the direction inclining to the −X side and the −Z side in the X direction is reflected by the reflective surface 102c and is easily guided to the sensor 16, as indicated by a two-dot chain line arrow in FIG. 8.

As illustrated in FIG. 8, in addition to the reflective surface 102b substantially parallel to the virtual plane VP, the reflective surface 102a inclining to the positive side with respect to the reflective surface 102b and the reflective surface 102a inclining to the negative side with respect to the reflective surface 102b are included in the reflective surface group 102, thereby making it possible to readily enlarge an angle range in which light can be guided to the sensor 16 at the incident angle in the vertical direction.

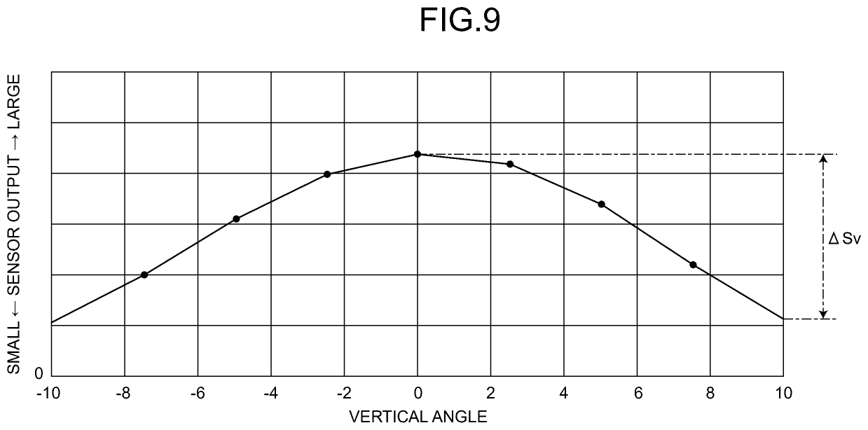

When this is graphed, it is indicated by a solid line in FIG. 9. FIG. 9 is a diagram illustrating vertical angle dependency of sensor sensitivity. In FIG. 9, it can be seen that a fluctuation range ΔSv of sensor sensitivity is relatively small and is suppressed within an allowable range in the angle range of −10° or more and +10° or less with respect to the incident angle in the vertical direction. It can be seen that −10° or more and +10° or less can be secured as the incident angle range in the vertical direction by a structure of the reflective surface group 102 illustrated in FIGS. 6 and 8.

The reflective surface 102b is substantially parallel to the virtual plane VP. Therefore, as indicated by a dotted arrow in FIG. 10, the light LBb incident onto the incident surface 101 in the X direction is reflected by the reflective surface 102b and is easily guided to the sensor 16. However, assuming that light LBe incident onto the incident surface 101 from a direction inclining to the −X side and the −Y side with respect to the X direction is reflected by the virtual plane VP, the light LBe may be emitted in a direction deviating from the sensor 16. Assuming that light LBh incident onto the incident surface 101 from the direction inclining to the −X side and the +Y side with respect to the X direction is reflected by the virtual plane VP, the light LBh may be emitted in a direction deviating from the sensor 16.

On the other hand, the reflective surface 102e inclines at the inclination angle θeh (>0) in the vertical direction with respect to the virtual plane VP. Therefore, the light LBe incident onto the incident surface 101 from the direction inclining to the −X side and the −Y side with respect to the X direction is reflected by the reflective surface 102e and is easily guided to the sensor 16, as indicated by an arrow of a one-dot chain line in FIG. 10.

The reflective surface 102h inclines at the inclination angle θhh (<0) in the horizontal direction with respect to the virtual plane VP. Therefore, the light LBh incident onto the incident surface 101 from the direction inclining to the −X side and the +Y side with respect to the X direction is reflected by the reflective surface 102h and is easily guided to the sensor 16, as indicated by a two-dot chain line arrow in FIG. 10.

As illustrated in FIG. 10, in addition to the reflective surface 102b substantially parallel to the virtual plane VP, the reflective surface 102e inclining to the positive side with respect to the reflective surface 102b and the reflective surface 102h inclining to the negative side with respect to the reflective surface 102b are included in the reflective surface group 102, thereby making it possible to readily enlarge an angle range in which light can be guided to the sensor 16 at the incident angle in the horizontal direction.

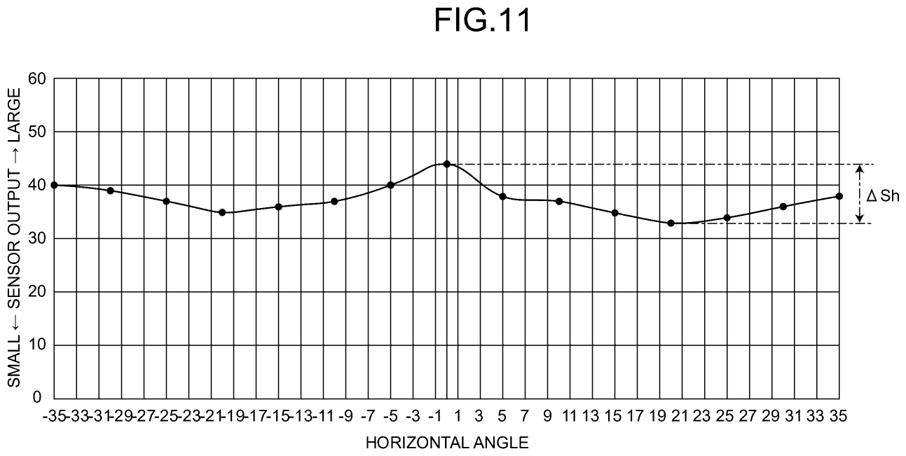

When this is graphed, it is indicated by a solid line in FIG. 11. FIG. 11 is a diagram illustrating horizontal angle dependency of sensor sensitivity. In FIG. 11, it can be seen that a fluctuation range ΔSh of the sensor sensitivity is relatively small and is suppressed within an allowable range in the angle range of −35° or more and +35° or less with respect to the incident angle in the horizontal direction. It can be seen that −35° or more and +35° or less can be secured as the incident angle range in the horizontal direction by a structure of the reflective surface group 102 illustrated in FIGS. 7 and 10.

As described above, in the present embodiment, the optical member 100 of the display device 1 includes the reflective surfaces 102a to 102i continuing to each other. The reflective surfaces 102a to 102i constitute a polygonal surface bulging out toward the opposite side of the incident side with respect to the virtual plane VP defined by the outer contours of the reflective surfaces 102a to 102i. With this structure, the optical member 100 can guide the incident light from the −X side to the sensor 16 in a wide angle range, and can expand the angle range in which the sensor 16 can detect the amount of light. Thus, it is possible to improve light guiding performance to the sensor 16 with respect to oblique incident light without using an expensive sensor.

It is noted that, in the reflective surface group 102 of the optical member 100, some of the reflective surfaces 102a to 102i may have different areas. In one example, the area of the reflective surface 102b provided at the center of the reflective surfaces 102a to 102i may be smaller than the areas of the other reflective surfaces 102a and 102c to 102i. The intensity of the incident light having a relatively small incident angle is stronger than the intensity of the incident light having a relatively large incident angle. Therefore, by making the area of the reflective surface 102b smaller than the areas of the other reflective surfaces 102a and 102c to 102i, the intensities of light received by the reflective surfaces 102a to 102i can be made close to each other.

Alternatively, the reflective surface group of the optical member may be obtained by dividing the virtual plane VP by N×M and deforming the virtual plane VP so as to bulge out toward the opposite side of the incident side while keeping a state where the N×M reflective surfaces are connected to each other. N is any integer of 2 or more. M is any integer of 2 or more. N and M may be the same as or different from each other. The values of N and M can be determined such that the areas of the respective divided reflective surface are equal to or larger than the area A1 of the light reception region 161 of the sensor 16. The values of N and M may be determined such that the areas of the respective divided reflective surfaces are equal to or larger than an area A2 (for example, 2.25 mm²) obtained by adding a margin relating to an optical error to the area A1. In the embodiment, a configuration of N=3 and M=3 is exemplified.

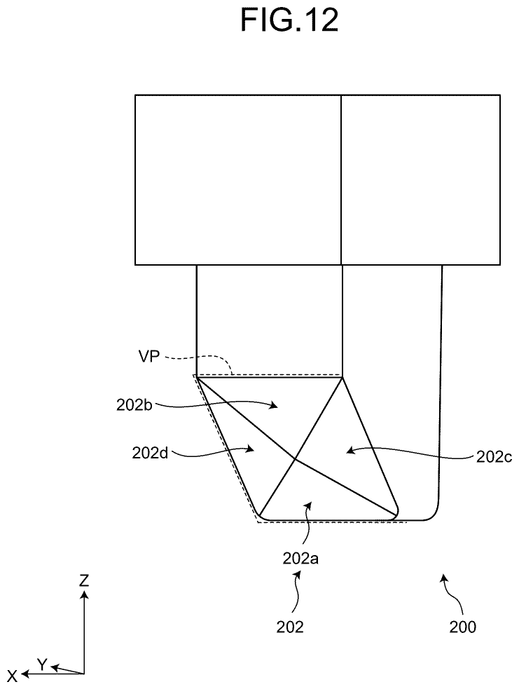

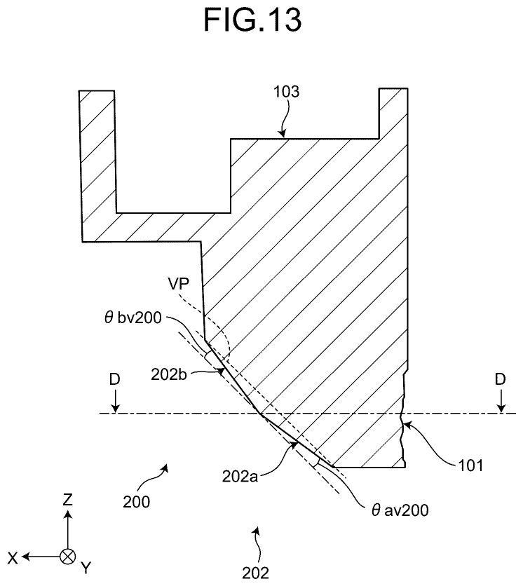

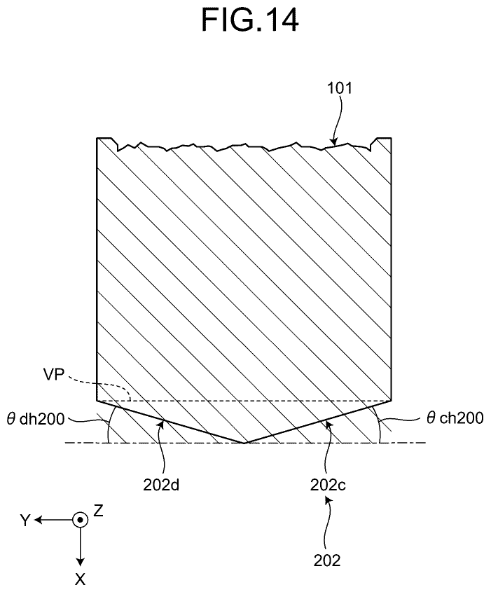

In the case of, for example, N=2 and M=2, an optical member 200 may be configured as illustrated in FIGS. 12 to 14. FIG. 12 is a perspective view illustrating a configuration of an optical member 200 according to a modification of the embodiment. FIG. 13 is an XZ cross-sectional view illustrating the configuration of the optical member 200 according to the modification of the embodiment, and corresponds to an XZ enlarged cross-sectional view of the section B in FIG. 4 as viewed from the −Y direction. FIG. 14 is an XY cross-sectional view illustrating the configuration of the optical member 200 according to the modification of the embodiment, and illustrates a cross section of FIG. 13 taken along line D-D.

The optical member 200 includes a reflective surface group 202 instead of the reflective surface group 102 (FIGS. 5 to 7). The reflective surface group 202 includes reflective surfaces 202a to 202d continuing to each other. The reflective surfaces 202a to 202d constitute a polygonal surface bulging out toward the opposite side of the incident side with respect to the virtual plane VP. The virtual plane VP is defined by the outer contours of the reflective surfaces 202a to 202d (refer to FIG. 12). With this structure, the optical member 200 can guide the incident light from the −X side to the sensor 16 in a wide angle range, and can expand the angle range in which the sensor 16 can detect the amount of light. Each of the reflective surfaces 202a to 202d has a substantially triangular shape in plan view.

The reflective surfaces 202a to 202d are obtained by dividing the virtual plane VP by 2×2 and deforming the virtual plane VP so as to bulge out toward the opposite side of the incident side while keeping a state where 2×2 reflective surfaces are connected to each other. The reflective surfaces 202a to 202d are connected to each other via straight sides.

At this time, the reflective surfaces 202a to 202d incline at an angle to each other. Each of the reflective surfaces 202a to 202d extends obliquely to the virtual plane VP.

The reflective surfaces 202a to 202d may have different incident angles of incident light shared with each other. The reflective surface 202a is allotted incident light having a relatively small incident angle and incident light having a relatively large incident angle in the vertical direction on the positive side. The reflective surface 202b is allotted incident light having a relatively small incident angle and incident light having a relatively large incident angle in the vertical direction on the negative side. The reflective surface 202c is allotted incident light having a relatively small incident angle and incident light having a relatively large incident angle in the horizontal direction on the positive side. The reflective surface 202d is allotted incident light having a relatively small incident angle and incident light having a relatively large incident angle in the horizontal direction on the negative side.

The reflective surface 202a is provided on the −Z side of the reflective surfaces 202b to 202d. The reflective surface 202a is connected to the reflective surface 202c at the sides on the −Y side and the +Z side. The reflective surface 202a is connected to the reflective surface 202d at the sides on the +Y side and the +Z side. The reflective surface 202a has a corner on the +Z side in contact with a corner of the reflective surface 202b. The reflective surface 202a inclines with respect to the virtual plane VP such that the side on the −Z side is closer to the virtual plane VP than the angle of the +Z side. An angle between the reflective surface 202a and the virtual plane VP corresponds to the incident angle of light to the incident surface 101. An inclination angle θah200 of the reflective surface 202a in the horizontal direction with respect to the virtual plane VP corresponds to an incident angle of light in the horizontal direction to be covered by the reflective surface 202a. An inclination angle θav200 of the reflective surface 202a in the vertical direction with respect to the virtual plane VP corresponds to an incident angle of light in the vertical direction to be covered by the reflective surface 202a.

The reflective surface 202a is allotted incident light having a relatively small incident angle and incident light having a relatively large incident angle in the vertical direction on the positive side. The angle between the reflective surface 202a and the virtual plane VP may be about ¼ of the incident angle of the incident light to be covered by the reflective surface 202a. If the optical member 200 is required to cover incident light having an incident angle of −10° or more and +10° or less in the vertical direction, the inclination angle θav200 (refer to FIG. 13) of the reflective surface 202a in the vertical direction with respect to the virtual plane VP may be approximately 2.5°. The inclination angle θah200 of the reflective surface 202a in the horizontal direction with respect to the virtual plane VP may be substantially 0.

The reflective surface 202b is provided on the +Z side of the reflective surfaces 202a, 202c, and 202d. The reflective surface 202b is connected to the reflective surface 202c at the sides on the −Y side and the −Z side. The reflective surface 202b is connected to the reflective surface 202d at the sides on the +Y side and the −Z side. The reflective surface 202b has a corner on the −Z side in contact with a corner of the reflective surface 202a. The reflective surface 202b inclines with respect to the virtual plane VP such that the side of the reflective surface 202b on the +Z side is closer to the virtual plane VP than the corner thereof on the −Z side. An angle between the reflective surface 202b and the virtual plane VP corresponds to the incident angle of light to the incident surface 101. An inclination angle θbh200 of the reflective surface 202b in the horizontal direction with respect to the virtual plane VP corresponds to an incident angle of light in the horizontal direction to be covered by the reflective surface 202b. An inclination angle θbv200 of the reflective surface 202b in the vertical direction with respect to the virtual plane VP corresponds to an incident angle of light in the vertical direction to be covered by the reflective surface 202b.

The reflective surface 202b is allotted incident light having a relatively small incident angle and incident light having a relatively large incident angle in the vertical direction on the negative side. The angle between the reflective surface 202b and the virtual plane VP may be about ¼ of the incident angle of the incident light to be covered by the reflective surface 202b. If the optical member 200 is required to cover incident light having an incident angle of −10° or more and +10° or less in the vertical direction, the inclination angle θbv200 (refer to FIG. 13) of the reflective surface 202b in the vertical direction with respect to the virtual plane VP may be approximately −2.5°. The inclination angle θbh200 of the reflective surface 202b in the horizontal direction with respect to the virtual plane VP may be substantially 0.

The reflective surface 202c is provided on the −Y side of the reflective surfaces 202a, 202b, and 202d. The reflective surface 202c is connected to the reflective surface 202a on the +Y side and the −Z side. The reflective surface 202c is connected to the reflective surface 202b on the +Y side and the +Z side. The reflective surface 202c has a corner on the +Y side in contact with a corner of the reflective surface 202d. The reflective surface 202c inclines with respect to the virtual plane VP such that the side of the reflective surface 202c on the −Y side is closer to the virtual plane VP than the corner thereof on the +Y side. An angle between the reflective surface 202c and the virtual plane VP corresponds to the incident angle of light to the incident surface 101. An inclination angle θch200 of the reflective surface 202c in the horizontal direction with respect to the virtual plane VP corresponds to an incident angle of light in the horizontal direction to be covered by the reflective surface 202c. An inclination angle θcv200 of the reflective surface 202c in the vertical direction with respect to the virtual plane VP corresponds to an incident angle of light in the vertical direction to be covered by the reflective surface 202c.

The reflective surface 202c is allotted incident light having a relatively small incident angle and incident light having a relatively large incident angle in the horizontal direction on the positive side. The angle between the reflective surface 202c and the virtual plane VP may be about ¼ of the incident angle of the incident light to be covered by the reflective surface 202c. If the optical member 200 is required to cover incident light having an incident angle of −35° or more and +35° or less in the horizontal direction, the inclination angle θch200 (refer to FIG. 14) of the reflective surface 202c in the horizontal direction with respect to the virtual plane VP may be approximately 10°. The inclination angle θcv200 of the reflective surface 202c in the vertical direction with respect to the virtual plane VP may be substantially 0.

The reflective surface 202d is provided on the +Y side of the reflective surfaces 202a to 202c. The reflective surface 202d is connected to the reflective surface 202a at the sides on the −Y side and the −Z side. The reflective surface 202d is connected to the reflective surface 202b at the sides on the −Y side and the +Z side. The reflective surface 202d has a corner on the −Y side in contact with a corner of the reflective surface 202c. The reflective surface 202d inclines with respect to the virtual plane VP such that the side of the reflective surface 202d on the +Y side is closer to the virtual plane VP than the corner thereof on the −Y side. An angle between the reflective surface 202d and the virtual plane VP corresponds to the incident angle of light to the incident surface 101. An inclination angle θdh200 of the reflective surface 202d in the horizontal direction with respect to the virtual plane VP corresponds to an incident angle of light in the horizontal direction to be covered by the reflective surface 202d. An inclination angle θdv200 of the reflective surface 202d in the vertical direction with respect to the virtual plane VP corresponds to the incident angle of light in the vertical direction to be covered by the reflective surface 202d.

The reflective surface 202d is allotted incident light having a relatively small incident angle and incident light having a relatively large incident angle in the horizontal direction on the negative side. The angle between the reflective surface 202d and the virtual plane VP may be about ¼ of the incident angle of the incident light to be covered by the reflective surface 202d. If the optical member 200 is required to cover incident light having an incident angle of −35° or more and +35° or less in the horizontal direction, the inclination angle θdh200 (refer to FIG. 14) of the reflective surface 202d in the horizontal direction with respect to the virtual plane VP may be approximately −10°. The inclination angle θdv200 of the reflective surface 202d in the vertical direction with respect to the virtual plane VP may be substantially 0.

In the above-described optical member 200 as well, the reflective surfaces 202a to 202d continuing to each other constitute a polygonal surface bulging out toward the opposite side of the incident side with respect to the virtual plane VP defined by the outer contours of the reflective surfaces 202a to 202d. With this structure, the optical member 200 can guide the incident light from the −X side to the sensor 16 in a wide angle range, and can expand the angle range in which the sensor 16 can detect the amount of light. Thus, it is possible to improve light guiding performance to the sensor 16 with respect to oblique incident light without using an expensive sensor.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
a display panel;
a transmission reflection member provided in front of the display panel;
a sensor configured to detect an amount of light corresponding to incident light incident onto the transmission reflection member; and
an optical member provided near the transmission reflection member, the optical member including reflective surfaces continuing to each other, the optical member being configured to receive light, reflect the light by the reflective surfaces, and guide the reflected light to the sensor, the reflective surfaces constituting a polygonal surface bulging out toward an opposite side of an incident side with respect to a virtual plane defined by outer contours of the reflective surfaces.

2. The display device according to claim 1, wherein an area of each of the reflective surfaces is equal to or larger than an area of a light reception region of the sensor.

3. The display device according to claim 1, wherein each of the reflective surfaces extends along the virtual plane.

4. The display device according to claim 1, wherein the reflective surfaces include
a first reflective surface extending along the virtual plane, and
a second reflective surface extending obliquely to the virtual plane.

5. The display device according to claim 4, wherein
the optical member further includes an incident surface on which light is incident, and
an angle between the second reflective surface and the virtual plane corresponds to an incident angle of the light to the incident surface.

6. The display device according to claim 4, wherein
the optical member further includes an incident surface on which light is incident, and
an angle between the first reflective surface and the second reflective surface corresponds to an incident angle of the light to the incident surface.

7. The display device according to claim 4, wherein an area of the first reflective surface is smaller than an area of the second reflective surface.

8. An optical member comprising:
an incident surface on which light is incident;
an emitting surface extending from an end part of the incident surface in a direction intersecting the incident surface, the emitting surface facing a sensor serving to detect an amount of light; and
reflective surfaces provided between the incident surface and the emitting surface in an optical path, the reflective surfaces continuing to each other, the reflective surfaces constituting a polygonal surface bulging out toward an opposite side of an incident side with respect to a virtual plane defined by outer contours of the reflective surfaces.

9. The optical member according to claim 8, wherein an area of each of the reflective surfaces is equal to or larger than an area of a light reception region of the sensor.

10. The optical member according to claim 8, wherein each of the reflective surfaces extends along the virtual plane.

11. The optical member according to claim 8, wherein the reflective surfaces include
a first reflective surface extending along the virtual plane, and
a second reflective surface extending obliquely to the virtual plane.

12. The optical member according to claim 11, wherein an angle between the second reflective surface and the virtual plane corresponds to an incident angle of the light to the incident surface.

13. The optical member according to claim 11, wherein an angle between the first reflective surface and the second reflective surface corresponds to an incident angle of the light to the incident surface.

14. The optical member according to claim 11, wherein an area of the first reflective surface is smaller than an area of the second reflective surface.
